(19) United States
(12) Patent Application Publication
(10) Pub. No.: US 2025/0061700 A1
(43) Pub. Date: Feb. 20, 2025

(54) METHOD AND SYSTEM FOR DETERMINING AN OBJECT STRUCTURE OF AN OBJECT AND CONTROL DEVICE FOR SUCH A SYSTEM

(71) Applicants: CARIAD SE, Wolfsburg (DE); Robert Bosch GmbH, Stuttgart (DE)

(72) Inventors: Daniel BAUER, Schiffweiler (DE); Sergej NEUMANN, Hagenbach (DE)

(21) Appl. No.: 18/806,574

(22) Filed: Aug. 15, 2024

(30) Foreign Application Priority Data
Aug. 17, 2023 (DE) 10 2023 122 052.7

(51) Int. Cl. G06V 10/82; G06V 10/25; G06V 10/44; G06V 10/764; G06V 10/766

(52) U.S. Cl. CPC G06V 10/82; G06V 10/25; G06V 10/44; G06V 10/764; G06V 10/766

(57) ABSTRACT

The disclosure relates to determining an object structure of an object, such as lane edges and/or lane markings. Image data describing an image of an environment with the object located therein are provided and then fed into at least one neural network that is trained to determine feature data, including predetermined features with respect to geometric shapes and/or colors of the object. Edge endpoints of the object structure of the object are determined by applying an edge endpoint determiner, and then an ROI operation is performed on at least one surrounding area around at least one determined edge endpoint. At the same time, intermediate graph points of the object structure are determined by applying an intermediate graph point determiner. The final object structure is determined and/or marked based on the determined edge endpoints and intermediate graph points. The determined object structure is provided to a computer vision functionality.

### BACKGROUND

### Technical Field

The disclosure relates to a method for determining an object structure of an object, comprising the steps of: providing image data which describe an image of an environment with the object located therein and which have been received from at least one sensor device; and feeding the image data into at least one neural network which is trained to determine feature data, the feature data comprising predetermined features (characteristics) with respect to basic geometric shapes (reference shapes) and/or colors of the object.

### Description of the Related Art

Object recognition is a sub-area of image processing that focuses on identifying individual objects in images. The term “object” refers, for example, to traffic islands and/or lane markings and/or lane edges and/or another vehicle. However, conventional methods, such as the use of bounding boxes or line recognition, have limitations as they can only recognize objects of a certain fixed shape as a whole. Providing a correct assignment and/or identification and/or sequence of pixels or pixel groups, in particular when detecting contiguous lines, is therefore an extremely challenging task. In order to ensure an advantageous design of such object recognition systems, it is therefore desirable to determine an object or an object structure or a center line of an object of any shape. In this context, “object structure” refers to the basic shape (e.g., a straight line) and/or the composition of the optical appearance of the object from such basic shapes or characteristics.

An object detection system that is specifically designed to detect lanes usually only considers highway scenarios in which lane markings and road edges can be described by straight lines. However, such an object recognition system fails in urban scenarios, for example, where objects such as lane edges and/or traffic islands can have any geometric shape, such as a polyline shape. A polyline shape or polyline refers to an open or closed sequence of connected line and/or arc segments and/or line segments that together no longer form a single straight line.

The publication “CondLaneNet: a Top-to-down Lane Detection Framework Based on Conditional Convolution” (Authors: Liu, Lizhe & Chen, Xiaohao & Zhu, Siyu & Tan, Ping. Published: 2021) discloses a method for detecting vertical lane lines in images. This method is based on line anchors and is not able to detect object structures of arbitrary shape.

The publication “A Keypoint-based Global Association Network for Lane Detection” (Authors: Wang, Jinsheng & Ma, Yinchao & Huang, Shaofci & Hui, Tianrui & Wang, Fei & Qian, Chen & Zhang, Tianzhu. Published: 2022) discloses a method for determining lane lines in which the lane lines are identified by a global assignment of marked endpoints of lines.

The publication “RCLane: Relay Chain Prediction for Lane Detection” (Authors: Xu, Shenghua & Cai, Xinyue & Zhao, Bin & Zhang, Li & Xu, Hang & Fu, Yanwei & Xue, Xiangyang. Published: 2022) discloses a method for determining lane lines using a global distance formulation that only works for straight lane lines.

The state of the art does not provide any possibilities to determine object structures of objects of any shape.

### BRIEF SUMMARY

The disclosure is based on the task of recognizing an object structure of an object in an environment, in particular a road traffic environment, on the basis of image data.

The disclosure provides a method for determining an object structure of an object. The method can, for example, be used as a component of a computer vision functionality to recognize an object in a motor vehicle in an environment of the motor vehicle with respect to its object structure. Based on the recognized object structure, for example, a driving trajectory for driving around the object (e.g., a traffic island) or for aligning the motor vehicle with respect to the object (e.g., a lane marking) can be calculated. The method comprises the following steps: image data describing an image of an environment with the object located therein is received or provided from at least one sensor device. The image data is fed into at least one artificial neural network which is trained to determine feature data, wherein the feature data comprises predetermined features or characteristics with regard to basic geometric shapes (reference shapes) and/or colors of the object. Such basic shapes can be, for example, horizontal and/or vertical lines and/or arcs, to name just a few examples.

The feature data can be determined by way of a so-called backbone, wherein the backbone is designed as the at least one artificial neural network, wherein the backbone comprises, for example, at least one residual neural network and/or densely connected convolutional network pre-trained on predetermined features with respect to basic geometric shapes and/or colors of the object. The at least one neural network may additionally or alternatively be trained on data containing polygonal shapes and/or structures. The feature data may, for example, comprise or be provided as a feature vector. In other words, the at least one neural network may be designed to receive image data or visual data from at least one sensor device and to determine and/or extract feature data therefrom. The at least one neural network may comprise a convolutional neural network (CNN) and/or a graph neural network (GNN). Additionally or alternatively, the at least one neural network may be configured as an encoder-decoder network, wherein the encoder-decoder network may be configured to perform semantic segmentation.

A so-called feature map can be generated from the at least one neural network. The at least one neural network may comprise a plurality of convolutional layers, whereby the feature map comprises a receptive field (such as capturing 3*3 to 200*200 pixels), which can, for example, capture objects such as traffic islands and/or road edges as a whole.

In at least one neural network, two different image processing functionalities can now be connected downstream, which can process the features from the feature map independently of each other.

In a step a), the at least one neural network comprises a so-called edge endpoint detector, which is designed to determine and/or mark edge endpoints and/or endpoints of the object structure of the object. The edge endpoints each mark a predefined object end area (in particular a line end) of the object. The feature data is subjected to a binary classification by way of the edge endpoint determiner, whereby the binary classification can include that feature vectors of the feature data are normalized and a normalized value, i.e., a classification value, above a predetermined threshold value is representative of having an edge endpoint of an object structure.

An edge endpoint can be recognized by the fact that an image area in the image data is recognized as part of a line shape (e.g., a curb) and, starting from this edge endpoint, a remainder of the line leads away in only one direction (instead of two different directions).

A so-called seed point map can be generated using the edge endpoint detector, whereby the seed point map has or indicates marked edge endpoints or so-called seed points. For example, if the image data shows a white lane arrow on a gray road surface, the two ends of the lane arrow (tip and opposite end) can be identified as edge endpoints. The edge endpoint identifier can be trained to identify shapes with a size in the range of 20×20 cm to 75×75 cm and which end in a spatial direction or do not extend any further in this direction. The object then ends in this direction and an edge endpoint can be set there. So-called seed point detection is used to determine one-dimensional points (edge endpoints or seed points). Start and/or endpoints that can be recognized as edge endpoints can therefore be learned.

In addition, “ROI pooling” (region of interest pooling) is provided and/or performed on at least one surrounding area around at least one determined edge endpoint. As a result, only or limited to network features or features at an area and/or position of at least one edge endpoint can be extracted.

ROI pooling or an ROI pooling operation can be used to specify a number of ROIs that are to be determined and/or selected in the image data (e.g., a maximum of 100 or 16 to 32). An ROI is, for example, image data that is to be examined together for a specific characteristic, such as a specified intensity of color values. Coordinates of the ROIs can be generated, for example, by a random function and/or according to a predefined generation pattern around the end points. Additionally or alternatively, a pooling window can be defined, whereby a size is determined to which the ROI areas are scaled. It can be specified as a fixed size, for example 7×7 to 14×14. Additionally or alternatively, a “stride value” can be determined, whereby the stride value defines a distance between pooling regions within an ROI area. Further definitions or settings relating to ROI pooling can be found in the prior art. ROI pooling can thus be used to determine the size of the extracted features for each ROI.

ROI pooling therefore makes it possible to extract features in image data from different regions, i.e., at the edge endpoints. The advantage resulting from the use of ROI pooling is that features or information can be extracted from a defined region, in this case at an edge endpoint, and/or reduced to a defined size. Instead of extracting information from the entire image, ROI pooling can focus on one or more specified or relevant regions and thus reduce calculations. In addition, ROI pooling takes into account the position and/or size of the ROIs in relation to the entire image data. This makes it robust against shifts and/or scaling of the ROIs. This is particularly advantageous for object detection and/or tracking.

Based on ROI pooling, at the position of an edge endpoint, the at least one artificial neural network can predict and/or reconstruct a number of R transitions from the edge endpoint along an actual, i.e., a “ground truth” line or line structure. “Ground truth” means an object structure or a single line that is actually present or depicted in the image but has yet to be recognized.

In a step b), the at least one neural network additionally comprises a graph intermediate point determiner or so-called keypoint head, which is designed to determine and/or mark graph intermediate points and/or nodes and/or connection points of the object structure of the object on the feature data. The intermediate graph points mark line geometric shapes of the object, whereby a line geometric shape is part of the object structure of the object. The line geometric shapes may be formed by straight lines and/or arcs and/or a mixture of both and/or polygonal surfaces. The above-mentioned transitions can be referred to as graph anchors. By creating the graph anchors, intermediate graph points can be connected to each other in pairs. Each intermediate graph point can provide a number of R transitions, whereby it can be provided that only that transition is reconstructed or used which most probably corresponds positionally or spatially to an actual ground truth instance. Additionally or alternatively, it may be provided that, for example, only the most probable 1 to 3 transitions are reconstructed according to the actual ground truth instance. This can result in one or more line segments. It may be provided that an estimated or reconstructed ground truth instance is mapped on a graph grid in order to provide an estimate in a clear and/or visualized manner.

Thus, using the ROIs, information can be extracted at determined edge endpoints to determine intermediate graph points starting from the at least one edge endpoint along an actual ground truth instance. The above-mentioned graph intermediate point determiner combines the advantages and/or the technical functions of anchors (anchor boxes) and graphs, as set out below. Inter alia, reduced post-processing (in the sense of a reduction criterion) can be achieved by integrating the properties of anchors. However, it may subsequently be necessary to perform a merge and/or a non-maximum suppression if, for example, duplicated line segments were generated for an (actual) ground truth instance to be reconstructed. Merging can mean, for example, bringing together or fusion of several determined line segments. Since an instance to be determined (ground truth line) is known during training, a prediction of at least one neural network can be smoothed or stabilized. In other words, fluctuations or uncertainties in the predictions or outputs can be avoided. In addition, noise reduction and/or robustness against overfitting can be achieved. Furthermore, a crossing and/or closing of several lines or line segments can be determined by integrating technical functions of anchors.

The graph intermediate point determiner also contains properties and/or advantages of a graph, i.e., (generic) lines or line geometries can be highlighted or marked, for example. Furthermore, the receptive field of the at least one neural network can be doubled, as at least one line can be coupled and/or created from a start and end point, i.e., two edge endpoints in each case. This results in a multiplication effect with regard to the receptive field of the at least one neural network. More precisely, from a first edge endpoint, an initial intermediate graph point can be interpreted as an initial intermediate graph point, and depending on the size of the receptive field to be shown, an estimate can be made up to a certain pixel marked by an intermediate graph point and/or a line segment can be modeled or constructed by way of the graph anchors. For example, two intermediate graph points can be connected by way of graph anchors, i.e., exhibiting, among other things, properties of a graph, if the receptive fields of the pixels representing these intermediate graph points overlap and/or influence each other.

In this way, graph anchors can be constructed that capture the structural and/or spatial relationships between the pixels in the image. A line can therefore be estimated and/or constructed from two ends, i.e., from the position of one edge endpoint to the position of another edge endpoint. As already mentioned, this can be realized by way of a local connection between the intermediate graph points via graph anchors, i.e., by using a component consisting of anchors and graphs. Furthermore, image data of different sizes can be processed without having to change the architecture and/or weighting of the at least one neural network.

The at least one neural network can thus be referred to as a graph anchor network. The intermediate graph points in the graph anchor network are thus specific points to which the at least one neural network directs its attention (in the sense of the attention defined for neural networks in the prior art, e.g., filters) and which are connected via graph anchors. In other words, the intermediate graph points serve as reference points for extracting and/or modeling information of a ground truth instance or line. The at least one neural network can thus enable scalable processing along the graph intermediate points with respect to a ground truth instance or line to be modeled.

The feature data can therefore be subjected to a further binary classification different from the first classification, i.e., relating to the determination of the edge endpoints, by way of the graph intermediate point determiner, whereby this second binary classification can comprise that feature vectors of the feature data are normalized and a normalized value, i.e., a classification value, above a predetermined threshold value is representative of having line geometric forms of an object structure.

The feature vectors can thus preferably each be subjected to a binary classification, whereby the feature vectors comprise parameterizable (numerical) properties of a geometric shape and/or a pattern of the object in a vectorial manner. Different features characteristic of the pattern can form different dimensions of the feature vectors. The feature vectors can therefore be used to facilitate the subsequent binary classification, as they greatly reduce the properties to be classified (instead of a complete image, for example, only one feature vector consisting of ten numbers needs to be considered). In the above example of the lane arrow, for example, individual line segments or line sections of the boundary line, which is formed by the transition from the white lane arrow and the gray road background, can each be identified as an intermediate graph point. For this purpose, the intermediate graph point detector can be trained to signalize sections or segments with a length measured in a range of 20 cm to 75 cm, which belong to a continuous line running in two directions in the surroundings, as intermediate graph points.

The determination of the edge endpoints of the object structure and the determination of the intermediate graph points are carried out independently of each other. The edge endpoint determiner and/or the graph intermediate point determiner may be included as a subnet and/or as at least one layer of the at least one neural network.

The object structure is therefore determined in step c) by way of the edge endpoints and the intermediate graph points in that, starting from an edge endpoint, pairs of neighboring intermediate graph points are connected to each other via graph anchors using a termination criterion, resulting in line segments. ROI pooling is performed at the edge endpoint to determine the direction in which a leading edge should be detected. In other words, one or more lines or line segments can be estimated and modeled as a “trivial” reconstructable graph. By “trivial”, it is meant that a reconstruction of a ground truth instance (e.g., a line shape) can be estimated and/or provided in the form of line segments based on existing information.

The determined object structure is then provided for a computer vision function. The computer vision function can, for example, be included in a motor vehicle as a parking aid and/or reversing system and/or lane detection system and/or lane change support system. Furthermore, the disclosure can be used for autonomous driving by performing longitudinal and lateral guidance of the motor vehicle by way of the determined object structure. The disclosure has the advantage that the object structure to be determined can comprise any geometric shapes, because the object structure is not described as a bounding box of a surface of the object, but is composed of intermediate graph points to be connected via graph anchors, which are lined up in the image data to form the (arbitrarily shaped) object structure.

To realize this method, a training method of the at least one neural network is described below in the description of figures.

The disclosure also includes further developments that result in additional advantages.

A further development provides that in step a), edge endpoints that have a classification value below a predetermined threshold value are deleted by way of a deletion criterion, thus remaining edge endpoints that indicate the start or end position of the object structure. For example, when determining edge endpoints using the first binary classification, a classification value (e.g., 80 out of 100 percentage points that the determined edge endpoint indicates, for example, an edge, in particular an end of a lane arrow) can be provided. The threshold value can then be defined in such a way that, for example, only the highest N classification values are retained (with N being an integer equal to 1 or greater than 1) and/or only those edge endpoints are determined and/or marked that have these respective classification values. This results in the advantage that duplicated or multiplied edge endpoints that have a classification value below the specified threshold value are deleted. The deletion criterion can be designed as a non-maximum suppression, for example.

According to an advantageous embodiment, it may be provided that a transformation operation for dimension reduction is performed in step b). More specifically, this transformation operation includes performing a reshaping and/or a 1×1 convolution of processed feature data, i.e., comprising determined edge endpoints and/or graph intermediate points and/or graph anchors. Reshaping refers to changing the shape or format of the input data or image data, in particular tensors, to match the expected input format of the at least one neural network. This can ensure compatibility between the layers of the at least one neural network. If the input of a CNN is a 2D image matrix, reshaping can be used to transform this 2D matrix into a vector that can serve as input for a (downstream) fully connected layer (FCL).

A 1×1 convolution, also known as point-wise convolution or network-in-network convolution, is a special form of convolution operation in a CNN. By applying a 1×1 convolution, different channels or feature maps can be combined and/or separated to increase the representational capability of at least one neural network and/or to reduce the number of dimensions. Another advantage of 1×1 convolution is that it can reduce the computations in a CNN, especially if it is applied before or after a larger convolution layer. This can increase the network performance of the at least one neural network and/or reduce the number of parameters to be trained.

According to a further development, it is provided that intermediate graph points are connected to one another by way of a regressive and/or a classifying method. The classifying method can comprise learning and/or setting a total of, for example, eight potential transitions in a square grid, i.e., graph anchors, for an intermediate graph point, i.e., on each side and/or corner of that intermediate graph point, in order to connect to a neighboring intermediate graph point. In this way, a discrete and/or delimitable transition to be marked can be achieved. An interpretation and/or visualization can thus be facilitated, since, for example, a threshold value must be exceeded for a transition to take place, and/or minor deviations and/or noise in the image data are thereby ignored.

For example, it may be provided that a transition probability for a transition is calculated as follows for the classifying method. For example, 0.9 is the classification probability, i.e., resulting from the (second) binary classification described above, for an intermediate graph point x and 0.75 is the classification probability for an intermediate graph point y (also resulting from the second binary classification), so that a transition probability for the transition between intermediate graph point x and intermediate graph point y is obtained, for example, by way of the following calculation:
Classification probability for intermediate graph point x: p_x=0.9
Classification probability for intermediate graph point y: p_y=0.75
Normalization factor (nf) for the classification probabilities:

$$nf = 1 / ( p\_x + p\_y )$$

The transition probability (ü) can then be calculated as follows:

$$\ddot{u} = nf * p\_x * p\_y$$

$$nf = 1 / ( 0.9 + 0.75 ) = 1 / 1.65 \approx 0.6061$$

$$\ddot{u} = 0.6061 * 0.9 * 0.75 \approx 0.4095$$

and therefore 0.4095 is the transition probability of the transition between intermediate graph point x and y. For example, all transition probabilities can be calculated for an intermediate graph point, whereby a connection is made with another intermediate graph point that has the highest transition probability.

Using the regressive method, on the other hand, transitions can be set or continued continuously and/or gradually. The regressive method therefore means that direction vectors can be learned and/or set. A direction vector in two-dimensional space, e.g., in the feature map and/or in an intermediate and/or output layer, consists of two numbers, as it represents the direction and the amount of a transition to be learned and/or set in a two-dimensional coordinate system. The two numbers therefore represent spatial changes in the x and y coordinates. From this, a smooth and/or natural transition between the intermediate graph points can be learned and/or set. A subtle and/or smooth or accurate “reconstruction” of the ground truth instance or line can thus be realized using the regressive method.

According to a further development, it is provided that the termination criterion in step c) is designed as a binary classifier which differs from the classifiers mentioned above, whereby the binary classifier checks pixels of feature data for features with regard to basic geometric shape and/or colors and terminates a connection of pairwise adjacent intermediate graph points as soon as a value below a predefined threshold value is determined. For example, color values of a pixel can be checked for intensity. Pixels are thus marked along an actual instance (ground truth line) via an intermediate graph point in each case until a predetermined threshold value is exceeded. In other words, the termination criterion checks whether an intermediate graph point to be generated lies on a ground truth line or instance. Alternatively, it can be provided that an interruption takes place when a predetermined length or viewing distance, measured by the size of the receptive field, has been reached.

A ground truth instance marked or modeled via graph anchors and graph intermediate points can be referred to as an (estimated) line segment. According to a further development, it is provided that line segments which have a classification value below a predetermined threshold value are deleted by way of a line deletion criterion, thus remaining line segments which indicate the object structure. This has the advantage that duplicated or multiplied line segments are deleted. The line deletion criterion can be designed as a non-maximum suppression, for example. Additionally or alternatively, it can be provided that one or more line segments merge with another line segment by considering an intersection angle of the line segments to be merged. This can be realized, for example, by way of the Hough transformation and/or the random sample consensus technique.

A further development provides for the feature data to be determined using a self-attention technique. The self-attention technique can be used to reduce the computational complexity of the at least one neural network for determining the feature data.

An advantageous embodiment provides for the determination of the object structure of the object to be trained by way of error feedback (backpropagation), whereby training data is used that has a label of the object structure. The at least one neural network is therefore trained using supervised learning. In backpropagation, an input, such as image data, which is transformed into input vectors, is propagated through the at least one neural network. The resulting output of the at least one neural network is compared with the desired output. The difference between the two values is considered to be an error in the neural network and the error is now propagated back to the input layer via the output layer. The weightings of the neuron connections of at least one neural network are changed depending on their influence on the error. This guarantees an approximation to the desired output when the input is applied again. The at least one neural network can be corrected (improved) by way of backpropagation. The parameters of the at least one neural network can thus be optimized or improved. With the parameters of the at least one neural network thus improved, the at least one neural network is suitable in the application phase for determining meaningful output vectors (outputs) from input vectors (inputs) that deviate from the originally learned input vectors of the training cases.

A further development provides for the feature data to be determined using a feature pyramid network technique (feature pyramid network). Using the feature pyramid network technique, so-called low-level (local) and high-level (semantic) features can be linked more closely.

For use cases or use situations which may arise during the method and which are not explicitly described here, it may be provided that an error message and/or a request for user feedback is output and/or a default setting and/or a predetermined initial state is set in accordance with the method.

The disclosure also includes a control device. The control device may comprise a data processing device or a processor device which is set up to carry out an embodiment of the method according to the disclosure. For this purpose, the processor device may comprise at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as the microprocessor. Furthermore, the processor device may comprise program code which is set up to carry out the embodiment of the method according to the disclosure when executed by the processor device. The program code may be stored in a data memory of the processor device. The processor device may, for example, be based on at least one circuit board and/or on at least one SoC (System on Chip).

The disclosure also includes a system comprising the control device and at least one sensor device. The system can carry out the method according to the disclosure by way of the control device.

The disclosure also includes a motor vehicle comprising the system. The motor vehicle according to the disclosure is preferably designed as a motor vehicle, in particular as a passenger car or truck, or as a passenger bus or motorcycle.

As a further solution, the disclosure also comprises a computer-readable storage medium comprising program code which, when executed by a computer or computer network, causes it to perform an embodiment of the method according to the disclosure. The storage medium may be provided at least in part as a non-volatile data storage medium (e.g., as a flash memory and/or as an SSD-solid state drive) and/or at least in part as a volatile data storage medium (e.g., as a RAM-random access memory). The storage medium can be arranged in the computer or computer network. However, the storage medium can also be operated as a so-called appstore server and/or cloud server on the Internet, for example. The computer or computer network can provide a processor circuit with, for example, at least one microprocessor. The program code can be provided as binary code and/or as assembler code and/or as source code of a programming language (e.g., C) and/or as a program script (e.g., Python).

The disclosure also includes combinations of the features of the embodiments described. The disclosure thus also includes implementations which each have a combination of the features of several of the embodiments described, provided that the embodiments have not been described as mutually exclusive.

### BRIEF DESCRIPTION OF THE SEVERAL VIEWS OF THE DRAWINGS

Examples of embodiments of the disclosure are described below.

FIG. 1 is a schematic representation of an embodiment of the method according to the disclosure,

FIG. 2 is a flow chart of an embodiment of the method according to the disclosure,

FIG. 3 is an illustration of an embodiment for practicing the present disclosure, and

FIG. 4 is a possible representation of predicted line segments according to one embodiment of the method according to the disclosure.

### DETAILED DESCRIPTION

The embodiments described below are advantageous embodiments of the disclosure. In the embodiment examples, the described components of the embodiments each represent individual features of the disclosure which are to be considered independently of each other and which also further form the disclosure independently of each other. Therefore, the disclosure is also intended to include combinations of the features of the embodiments other than those shown. Furthermore, the described embodiments can also be supplemented by further features of the disclosure already described.

In the figures, identical reference signs denote elements with the same function.

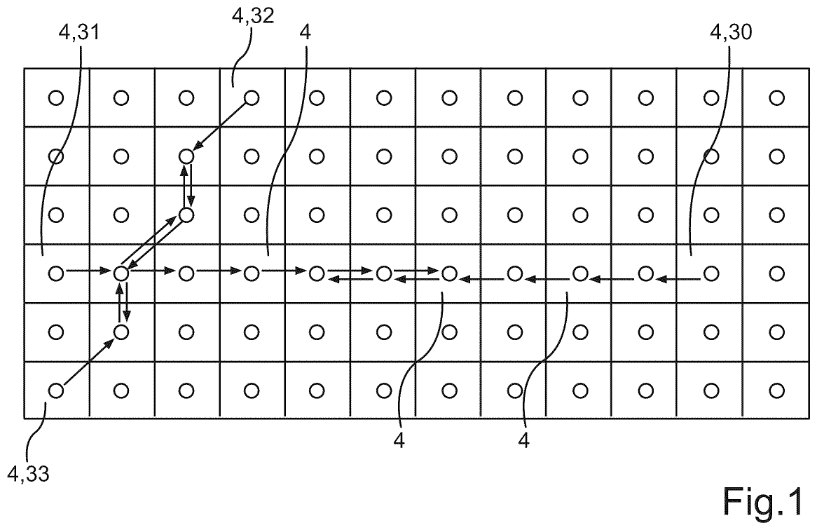

FIG. 1 shows how, starting from a starting position, intermediate graph points 4 can connect via graph anchors. The at least one neural network could here, for example, estimate that an initial graph intermediate point 30, i.e., an intermediate graph point 4 from which an estimate starts, lies on the same course of an actual instance as the initial graph intermediate point 31. Due to the limited size of the receptive field, it can happen that intermediate graph points 4 from two sides couple and/or connect to form a common estimated and/or simulated instance. The same can be shown with respect to the initial graph intermediate points 32 and 33. Although the two lines to be estimated and/or reconstructed cross each other, this does not pose a problem due to the properties of the graph anchors involved, so that an originally estimated line can still be traced and/or reconstructed.

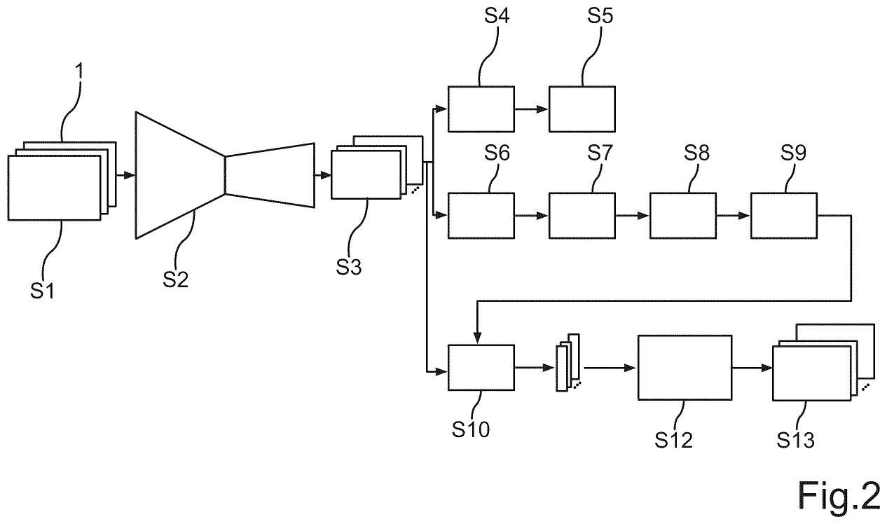

FIG. 2 shows an embodiment for determining an object structure of an object. In a step S1, image data 1 can be provided which describe an image of an environment with the object located therein and which were received from at least one sensor device and/or have any desired dimensionality. These can be fed into at least one neural network in S2, whereby feature extraction can be carried out using, for example, network convolutional layers. The at least one neural network can be trained to determine feature data, with the feature data comprising predefined features with regard to basic geometric shapes and/or colors. In S3, this can result in a feature map. In a step S6, edge endpoints can be determined by applying an edge endpoint determiner of the at least one neural network to the feature data, wherein in S7 edge endpoints mark a predetermined object end region of the object in each case. In S8, a deletion criterion can be applied to the determined edge endpoints, remaining edge endpoints in S9 that indicate the start or end position of the object structure. In a parallel step S4, intermediate graph points 4 can be determined.

A combination of different libraries and/or frameworks for object recognition (e.g., TensorFlow, PyTorch) and/or for graph algorithms (e.g., NetworkX) can be used for the actual programming of the process.

The at least one neural network can have a graph intermediate point determiner or so-called keypoint head, which is designed to determine and/or mark graph intermediate points 4 and/or node points and/or connection points of the object structure of the object on the feature data. The graph intermediate points 4 can mark line geometric shapes of the object, wherein a line geometric shape is part of the object structure of the object. The line geometric shapes may be formed from straight lines and/or arcs and/or a mixture of both and/or polygonal surfaces. In a step S5, intermediate graph points 4 may then be mapped, for example on an intermediate graph point map. In a step S10, a region of interest (ROI) operation can be provided and/or performed on at least one surrounding area around at least one determined edge endpoint. Features extracted from this can be transformed in their dimensionality in a step S12 by way of reshaping and/or 1×1 convolution in order to ensure compatibility between the layers of the at least one neural network.

In a step S13, the object structure can be determined by way of the edge endpoints and the graph intermediate points 4, in that, starting from an edge endpoint, neighboring graph intermediate points 4 are connected to each other in pairs via graph anchors using a termination criterion, and line segments L are created as a result. These line segments L can then show an object structure, whereby the object structure can be provided for a computer vision function.

As an example, the procedure can be represented as an optimization process as follows:
2 Nl R·(NumTransit+1)
NI·=Number of line segments 2=An estimate can start from an edge endpoint, whereby preferably 2 edge endpoints form the start and endpoint of a line segment
R=size of the receptive field
NumTransit=classifying and/or regressive method, e.g., 8 when using a classification or as a direction vector when using a regressive method
1=Value for termination criterion

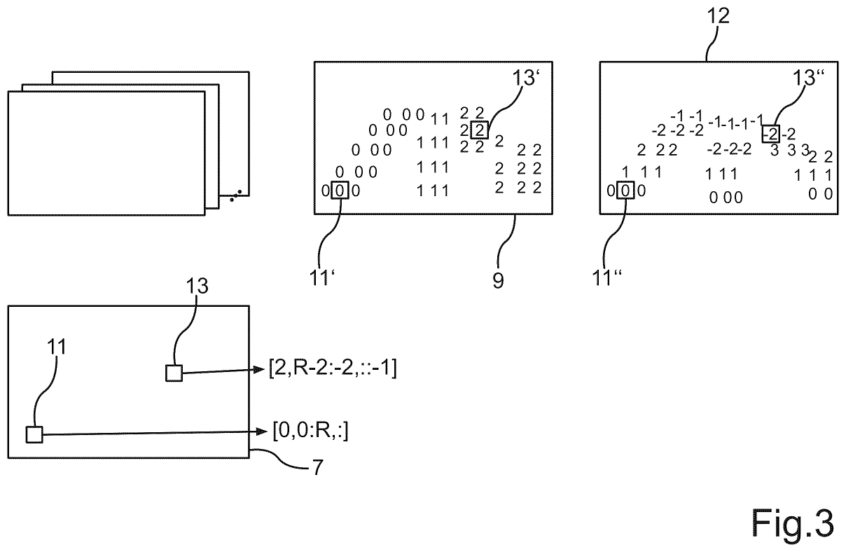

The at least one neural network can be trained according to one embodiment, as shown in FIG. 3, as follows. The ground truth lines or polylines in the image data 1 can therefore have N lines and/or N points (i.e., pixels or image points over which the ground truth line segment or the ground truth line runs). By way of a so-called matcher or label matcher, information, here e.g., ID digits, which describe the course of ground truth line segments in a first part of the lookup table, for example called instance table 9, can be manually or automatically defined and/or provided for the at least one neural network in the form of a lookup table. The starting point of the lookup table can be an edge endpoint table 7, which has predicted edge endpoints, as shown in the side area of FIG. 3 bottom left. The at least one neural network can then “look up” or check the ID number, e.g., of the predicted edge endpoint 11, which can be called instance ID 11′, in the instance table 9, whereby this is a zero.

Based on this, an estimate can then be made, from which, for example, the position of the looked-up ID digit is reproduced or approximated, in particular by setting an intermediate graph point 4 via graph anchors. This can be mapped on a so-called index table 12. Depending on how good or bad an estimate is, a corresponding value or another estimated ID digit can be mapped. The mapped estimated zero, which is an index ID 11″ in the index table 12, can mean that the position of the predicted edge endpoint 11 was reproduced exactly according to a ground truth instance. If an estimated ID digit has a value outside 0 and/or 1, for example, an additional cost function can be integrated into a loss function as a result in order to prevent the occurrence of such an erroneous and/or inaccurate estimate.

The position and/or the further course of the predicted edge endpoint 11 can be described as follows: [0, 0: R,:], whereby this description is based on rules of the slicing operation of the Python programming language. R stands for the receptive field, which means that an estimate can be made up to the end of the respective receptive field. As the estimation is continued from the bottom (edge endpoint 11) to the top, the number on the right is omitted, as this is a “normal” or non-inverted sequence. In other words, the signs of the ID digits can be used to control a direction and/or a course of intermediate graph points 4 and/or graph anchors to be built up. In the case of edge endpoint 13, the estimation is performed from top to bottom, which is why the indexing according to the slicing operation is described in inverted form, since it is a “reverse” sequence and indexing. The edge endpoint table 7 and/or the instance table 9 and/or the index table 12 can be one-dimensional.

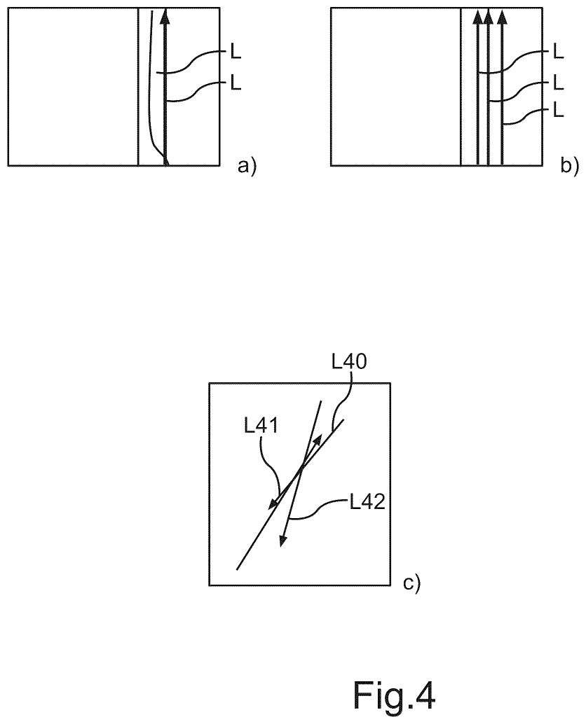

FIG. 4 shows several possible implementations according to one embodiment of the method according to the disclosure. In 4 a) it is shown how an estimate can be made in relation to a ground truth line using a binary classification to determine the intermediate graph points 4. In particular, the color values and/or the intensity of the colors of the ground truth line segment or the line can influence a binary classification carried out for estimation to the extent that a line segment L to be imitated, i.e., estimated, is shifted to a centered position. If, for example, 8 graph anchors are predicted for an intermediate graph point 4, it may be intended to reconstruct only the graph anchor that has the highest classification value. In 4 b) it is shown that several estimates can be made and/or mapped to a ground truth line, whereby the left estimated line segment L according to the binary classification according to 4 a) would have the highest classification value or the highest total probability, having several classification values, measured, e.g., on all transition probabilities.

In 4 c) it is shown that line segment L41 can be merged and/or combined with line segment L40 by considering an intersection angle of the line segments L40, L41 to be combined or merged. In this example, line segment L42 can be disregarded, since this line segment has a larger intersection angle to line segment L40 than line segment L41. It can therefore be designated as line segment L42 that is not to be merged. This can be realized, for example, using the Hough transformation and/or the random sample consensus technique.

The overall idea is therefore that start and endpoints, i.e., preferably two related edge endpoints or seed points, are learned. At the position of these seed points, the at least one neural network R can predict or predict transitions from the seed point along a ground truth line, which can be referred to as graph anchors (R: size of the receptive field). Thus, as mentioned earlier, since predicting graph anchors for each pixel is too computationally expensive, ROI pooling is used, which only extracts network features at the seedpoint locations. These features can be forwarded to a second-stage classifier (binary classifier) to predict or estimate the actual graph anchors. In other words, an estimation can be performed for each pixel, especially pixels at an ROI region, checking what a line segment to be reconstructed according to a ground truth instance would look like.

In this case, the ROI pooling can be differentiable so that a joint end-to-end training of the at least one neural network of the first and second stage (providing edge endpoints and/or graph intermediate points and/or graph anchors) is possible. Finally, in order to obtain labels for the predictions or estimation, the graph anchors, consisting of graph intermediate points 4 and graph anchors, can be provided with an additional instance and index image (instance table 9 and index table 12). These two images define the corresponding instance and index for each pixel in order to directly extract the corresponding ground truth, i.e., the actual ground truth line segments. In addition, the sign of the indices or the ID digits can define whether the direction of the graph anchors should be inverted in the case of lines or line segments that are aligned from end to start. Graph anchors that begin at a start point and/or endpoint build the line from both ends.

Overall, the examples show how a so-called graph anchor network can be provided for determining or detecting lines.

German patent application no. 10 2023 122 052.7, filed Aug. 17, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for determining an object structure of an object, comprising:
providing image data that describe an image of an environment with the object in the environment, wherein the image data are received from at least one sensor device; and
feeding the image data into at least one neural network that is trained to determine feature data, wherein the feature data include predetermined features relating to geometric shapes and/or colors of the object;
a) determining edge endpoints of the object structure of the object by applying an edge endpoint determiner of the at least one neural network to the feature data, wherein the edge endpoints in each of a plurality of case mark a predetermined object end region of the object, and wherein in a Region of Interest (ROI) pooling a region of interest operation, ROI operation, is provided and/or performed on at least one surrounding region around at least one determined edge endpoint;
b) determining intermediate graph points of the object structure by applying an intermediate graph point determiner of the at least one neural network to the feature data, wherein the intermediate graph points mark line geometric shapes of the object, and wherein each of the line geometric shapes is a part of the object structure of the object,
wherein a) and b) are performed independently of each other;
c) determining the object structure by way of the edge endpoints and the graph intermediate graph points by connecting adjacent ones of the intermediate graph points in pairs starting from a respective edge endpoint using a termination criterion and subsequently determining line segments; and
d) providing the object structure to a computer vision function.

2. The method according to claim 1, wherein in a) the edge endpoints include a classification value and the edge endpoints that have a classification value below a predetermined threshold value are deleted by way of a deletion criterion, and remaining ones of the edge endpoints indicate a start position or an end position of the object structure.

3. The method according to claim 1, wherein in b) a transformation operation for dimension reduction is performed.

4. The method according to claim 1, wherein the intermediate graph points are connected to each other by way of a regressive and/or a classifying method.

5. The method according to claim 1, wherein the termination criterion in c) is a binary classifier that checks pixels of feature data for features with respect to the geometric shapes and/or colors and terminates a connection of the adjacent ones of the intermediate graph points in pairs as soon as a value below a predetermined threshold value is determined.

6. The method according to claim 1, wherein line segments comprise a classification value and line segments having a classification value below a predetermined threshold value are deleted by way of a line deletion criterion, and remaining line segments indicating the object structure.

7. The method according to claim 1, wherein the at least one neural network is trained to determine the object structure by way of error feedback, and wherein training data that have a labeling of the object structure are used to train the at least one neural network.

8. The method according to claim 1, wherein the feature data are determined by way of a self-attention technique.

9. The method according to claim 1, wherein the feature data are determined using a feature pyramid network technique.

10. A control apparatus for a system, the control apparatus comprising:
a processor; and
a memory storing program instructions that, when executed by the processor, cause the control apparatus to:
provide image data that describe an image of an environment with an object in the environment, wherein the image data are received from at least one sensor device; and
feed the image data into at least one neural network that is trained to determine feature data, wherein the feature data include predetermined features relating to geometric shapes and/or colors of the object;
a) determine edge endpoints of an object structure of the object by applying an edge endpoint determiner of the at least one neural network to the feature data, wherein the edge endpoints in each of a plurality of case mark a predetermined object end region of the object, and wherein in a Region of Interest (ROI) pooling a region of interest operation, ROI operation, is provided and/or performed on at least one surrounding region around at least one determined edge endpoint;
b) determine intermediate graph points of the object structure by applying an intermediate graph point determiner of the at least one neural network to the feature data, wherein the intermediate graph points mark line geometric shapes of the object, and wherein each of the line geometric shapes is a part of the object structure of the object,
wherein a) and b) are performed independently of each other;
c) determine the object structure by way of the edge endpoints and the graph intermediate points by connecting adjacent ones of the intermediate graph points in pairs starting from a respective edge endpoint using a termination criterion and subsequently determine line segments; and
d) provide the object structure to a computer vision function.

11. A system comprising a control device according to claim 10, further comprising:
at least one sensor device that, in operation, determines the image data.
